(19) United States
(12) Patent Application Publication
(10) Pub. No.: US 2018/0039297 A1
(43) Pub. Date: Feb. 8, 2018

(54) APPARATUS AND METHOD FOR ADJUSTING A ROTARY OR PIVOTING MOVEMENT OF A CONTROL ELEMENT FOR A VEHICLE

(71) Applicant: ZF Friedrichshafen AG, Friedrichshafen (DE)

(72) Inventor: Alex Hessel, Lemförde (DE)

(73) Assignee: ZF Friedrichshafen AG, Friedrichshafen (DE)

(21) Appl. No.: 15/548,974

(22) PCT Filed: Jan. 11, 2016
(86) PCT No.: PCT/EP2016/050331

§ 371 Date: Aug. 4, 2017

(30) Foreign Application Priority Data
Feb. 5, 2015 (DE) 10 2015 201 976.4

(51) Int. Cl. G05G 1/08; B60K 37/06; G05G 5/06

(52) U.S. Cl. CPC G05G 1/08; G05G 5/06; B60K 37/06

(57) ABSTRACT

Provision is made for a device for setting a rotational movement or pivoting movement of a control element for a vehicle. To this end, the device comprises a curved latching contour for defining at least a shift position of the control element. The device also comprises a latching element for engaging in the latching contour. Furthermore, the device comprises a power transmitting device, with which the control element can be mechanically connected, in order to absorb mechanical forces exerted on the control element during the rotational movement or pivoting movement of the control element and transmitting said forces to the latching element. The device is characterized in that the latching element can be arranged to be swivel-mounted on the power transmitting device, wherein due to the operating force the latching element can be moved in rolling fashion along the latching contour.

The present disclosure relates to a device for setting a rotational movement or pivoting movement of a control element for a vehicle and a method for adjusting a rotational movement or pivoting movement of a control element for a vehicle.

A so-called latching device can comprise, for example, a locking pin, a locking ball, a latching roller or the like. Such a latching device can be used in the automotive or vehicle sector in conjunction with electrical switching devices, for example, an automatic shift transmission, or for guidance and haptic position feedback of a rotary switch, shift lever or selector lever. DE 10 2007 038 547 A1 discloses a rotary switch with latching.

Against this background, the present disclosure provides an improved device for setting a rotational movement or pivoting movement of a control element for a vehicle and an improved method for adjusting a rotational movement or pivoting movement of a control element for a vehicle according to the main claims. Advantageous embodiments are included in the sub-claims and subsequent description.

According to embodiments of the present disclosure, it is especially possible to provide a device for locking, or a latching device for a control element of a vehicle, wherein a latching element can be rolled along a latching contour. At the same time, the latching element can be arranged to be swivel-mounted in a power transmitting carrier device. The carrier device or power transmitting device can be designed to move the latching element in a rotational manner along the latching contour, when a control element, with which the device can be connected, is activated.

Embodiments of the present disclosure have the advantage that wear and tear can be reduced when, for example, the latching element can roll along the latching contour instead of grinding or slipping on the latching contour. In addition to reduced wear and tear on the latching element and latching contour, it is also possible to improve haptics when activating or operating the control element. Furthermore, it is possible to reduce the number of components of the device and thus shorten the tolerance chain.

A device for setting a rotational movement or pivoting movement of a control element for a vehicle comprises a curved latching contour for defining at least a shift position of the control element, a latching element for engaging in the latching contour and a power transmitting device, with which the control element can be mechanically connected, in order to absorb mechanical forces exerted on the control element during the rotational movement or pivoting movement and transmitting said forces to the latching element, wherein the latching element can be arranged to be swivel-mounted on the power transmitting device, wherein due to the operating force the latching element can be moved in rolling fashion along the latching contour.

The vehicle can involve a motor vehicle, especially a vehicle used for road transport, such as a passenger car or truck. Alternatively, the vehicle can involve, for example, a rail vehicle or an aircraft. The device can be used for adjusting a rotational movement or pivoting movement of a control element of a machine, for example, a vehicle. The device can involve a piece of equipment or part of an equipment of the vehicle. The device can be denoted as a latching device. For example, the control element can be used to select a speed level of an automatic transmission of the vehicle. In particular, the control element can be operated manually by a driver of the vehicle, to adjust different speed levels or gears of the automatic transmission. The control element can also be designed as a joint control element to perform different vehicle functions. In particular, the control element can involve a rotary knob or the like. As a result, the device together with the control element can represent a rotary switch or the like. For example, the rotational movement or pivoting movement of the control element can be performed between at least two shift positions or positions, and additionally or alternatively, between a rest position and at least a deflection position. The latching contour can be arranged, shaped, and additionally or alternatively, designed to guide the latching element, and additionally or alternatively, enable a resistance or a sensor, in particular haptic feedback with respect to a rotational movement or pivoting movement or shift position of the control element. A section of the latching element can be engaged with a section of the latching contour and, because of the operating force, moved in rotational manner along the latching contour. At the same time, said engagement can take place in a frictional and form-fitting manner between the section of the latching element and the section of the latching contour. The power transmitting device can be designed in such a way that it can be connected with a shifting device to produce control signals, depending on the rotational movement or pivoting movement of the control element. The power transmitting device can be mechanically rigidly connected with the control element.

According to one embodiment, the latching element can comprise a centrally arranged bearing segment for supporting the power transmitting device and a peripherally arranged engaging portion for engaging in the latching contour. The bearing segment can have at least one bearing pin for reception in the power transmitting device. In a rotational movement in relation to the power transmitting device, a rotational axis of the latching element can extend through the bearing segment. At the same time, the rotational axis can represent a symmetrical axis of the latching element. The bearing segment can be surrounded at least partially by the engaging portion. Such an embodiment has the advantage that haptics, as well as ease of operation can be improved and imbalances can be minimized.

The bearing section of the latching element can be formed from a hard material with a first elasticity, wherein the engaging portion of the latching element is formed from a soft material with a second elasticity. The second elasticity of the soft material can be greater than the first elasticity of the hard material. For example, such a latching element can consist of or be formed as a one-piece or two-piece component by means of two-component-injection molding process or the like. Such an embodiment has the advantage of reduced noise when operated. The use of the soft material or a soft component can be utilized to generate force, and the use of the soft material can also eliminate the need for compression springs or the like.

In particular, the latching element can comprise at least three projections for engaging in the latching contour. The projections can be produced in the form of legs, arms, noses, or the like. For example, the latching element can be designed to have three, four, five or more legs. The projections can extend radially from a center of the latching element. When the latching element is rotated along the latching contour, at least one projection can be engaged with the latching contour, wherein at least one further projection can be disengaged from the latching contour. Such an embodiment has the advantage of improving the haptics, as well as generating different forces and/or positioning angles for the control element, depending on the number of projections.

According to one embodiment, the latching contour can have a contact section, which is designed to enable an engagement of the latching element. To this end, at least the contact section of the latching contour can be formed from a soft material with an elasticity that is greater than the elasticity of a material of the power transmitting device. Such an embodiment has the advantage that noises generated during operation can be better absorbed when using a soft material or soft component for the latching contour. In addition, the soft material can be used for generating force during an operation and thus eliminate compression springs.

The power transmitting device can also comprise an elastic material, which can be designed to preload the latching element in abutment against the latching contour. In this connection, the power transmitting device can have a first section and a second section, wherein the control element can be mechanically coupled with the first section and the latching element can be arranged to be swivel-mounted with the second section. At the same time, the elastic means can be arranged between the first section and the second section to preload the second section in relation to the first section. Such an embodiment has the advantage that the haptics can be improved when operating the control element and enhance the positional accuracy of shift positions of the device.

For example, the latching contour can have a circular design. To this end, a contact section of the latching contour, which can be designed to enable an engagement of the latching element, can be arranged in radially inward direction. Such an embodiment has the advantage that the device can be shaped in a space-saving manner and ensure that the latching element is guided reliably in the latching contour.

Furthermore, the power transmitting device can have a first rotational axis, wherein the latching element can have a second rotational axis. To this end, the first rotational axis and the second rotational axis can be arranged in parallel manner to each other. Because of the operating force, the power transmitting device and the latching element can be designed to rotate relative to each other in opposite direction about the rotational axes. In particular, the power transmitting device and the latching element can have a mutual rotation level or parallel rotation levels. Such an embodiment has the advantage of allowing for an especially space-saving embodiment of the device. Furthermore, the control element is easy to operate, but also exact. It is also possible to improve the haptics when using the control element.

A method for adjusting a rotational movement or pivoting movement of a control element for a vehicle comprises a step in which the operating force is absorbed from the control element by the power transmitting device and a step in which the operating force is transmitted by the power transmitting device to the latching element, wherein the method can be performed in conjunction with an embodiment of the above-mentioned device.

The method can be advantageously performed in conjunction with or by using an embodiment of the above-mentioned adjusting device to adjust a rotational movement or pivoting movement of a control element for a vehicle.

A shifting device, especially for shifting an automatic transmission of a vehicle, comprises a control element and an embodiment of the above-mentioned device for setting a rotational movement or pivoting movement of the control element, wherein the control element is, or can be, connected with the power transmitting device of the adjusting device. In connection with the shifting device, an embodiment of the above-mentioned adjusting device can be advantageously used or utilized to adjust a rotational movement or pivoting movement of the control element. When the device is assembled, the latching element of the device can be arranged in abutment against the latching contour. Furthermore, the device can have a carrier device, on which the latching contour, the power transmitting device and the latching element can be arranged.

Subsequently, the disclosure is described in more detail in an exemplary manner by means of the enclosed drawings. It is shown:

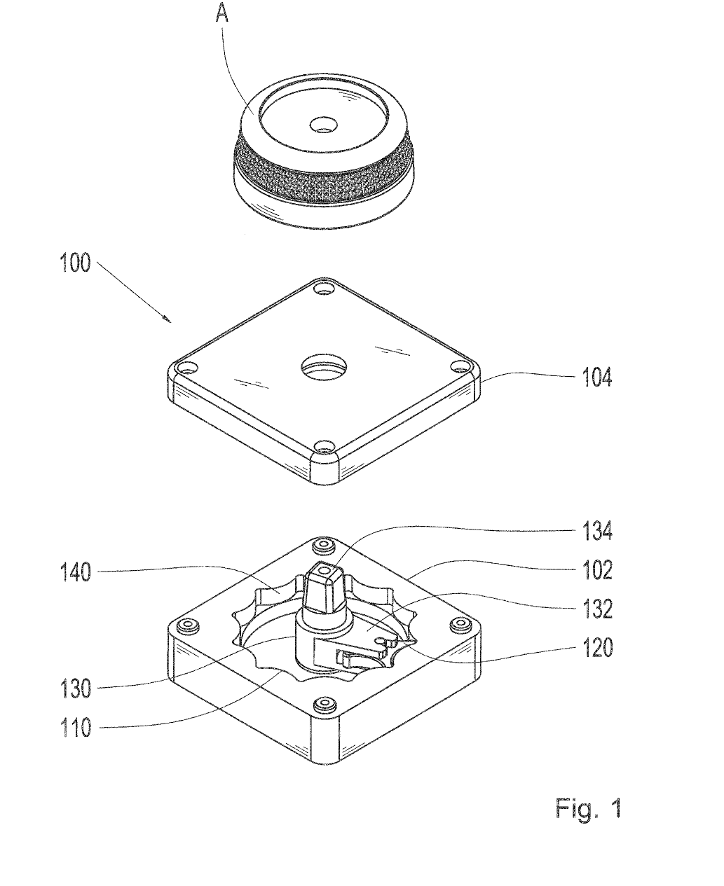

FIG. 1 is a perspective view of an adjusting device according to an embodiment of the present disclosure in a partially mounted condition;

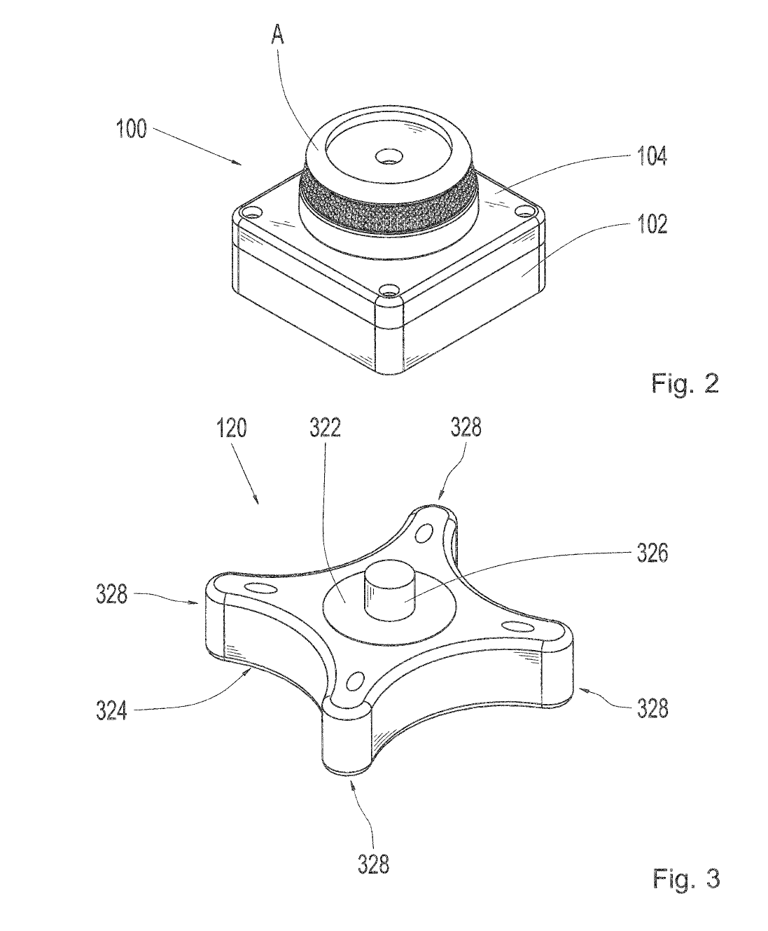

FIG. 2 is a perspective view of the device shown in FIG. 1 in a mounted condition;

FIG. 3 is a perspective view of the latching element of the device shown in FIG. 1 or FIG. 2;

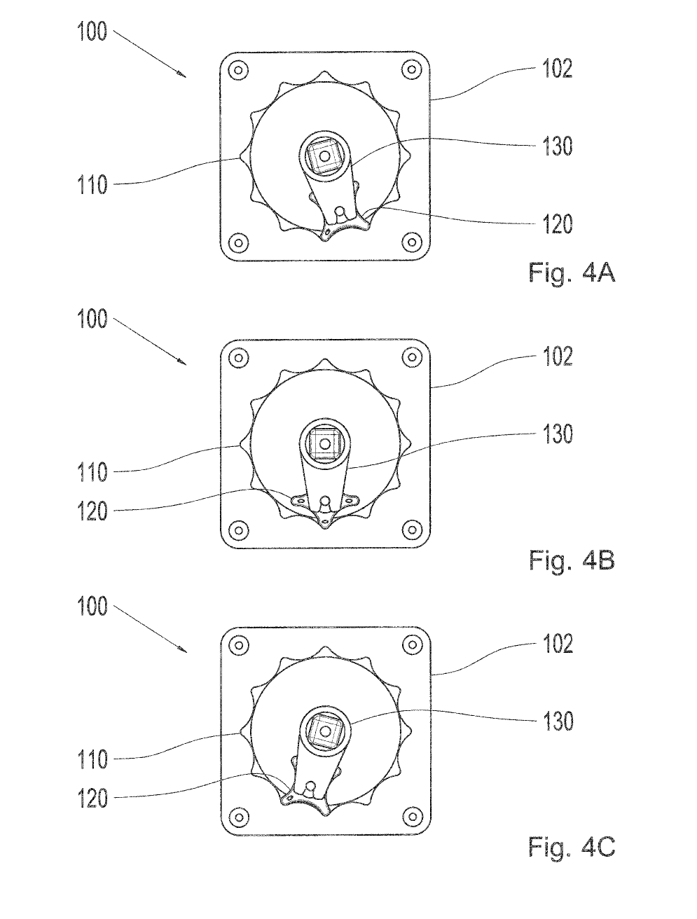

FIGS. 4A to 4C are top views of the device shown in FIG. 1 or FIG. 2 in different conditions of movement;

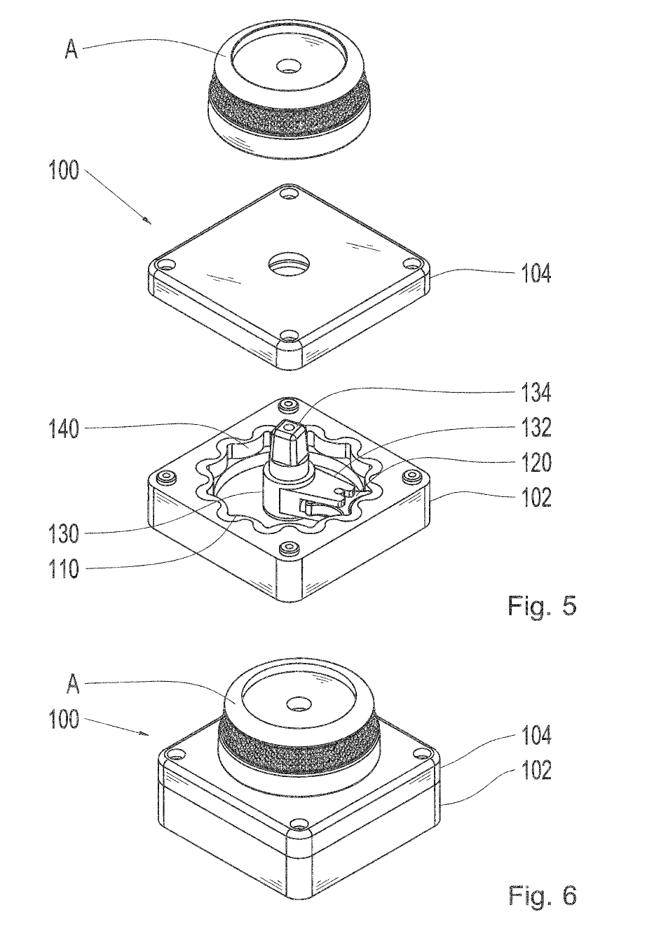

FIG. 5 is a perspective view of an adjusting device according to a further embodiment of the present disclosure in a partially mounted condition;

FIG. 6 is a perspective view of the device shown in FIG. 5 in a mounted condition;

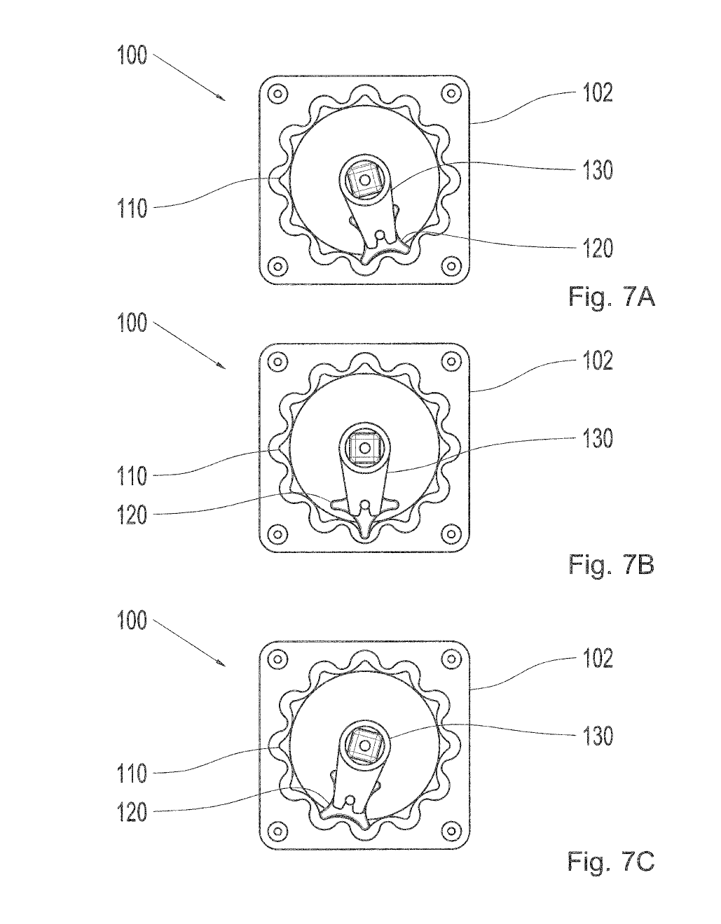

FIGS. 7A to 7C are top views of the device shown in FIG. 5 or FIG. 6 in different conditions of movement;

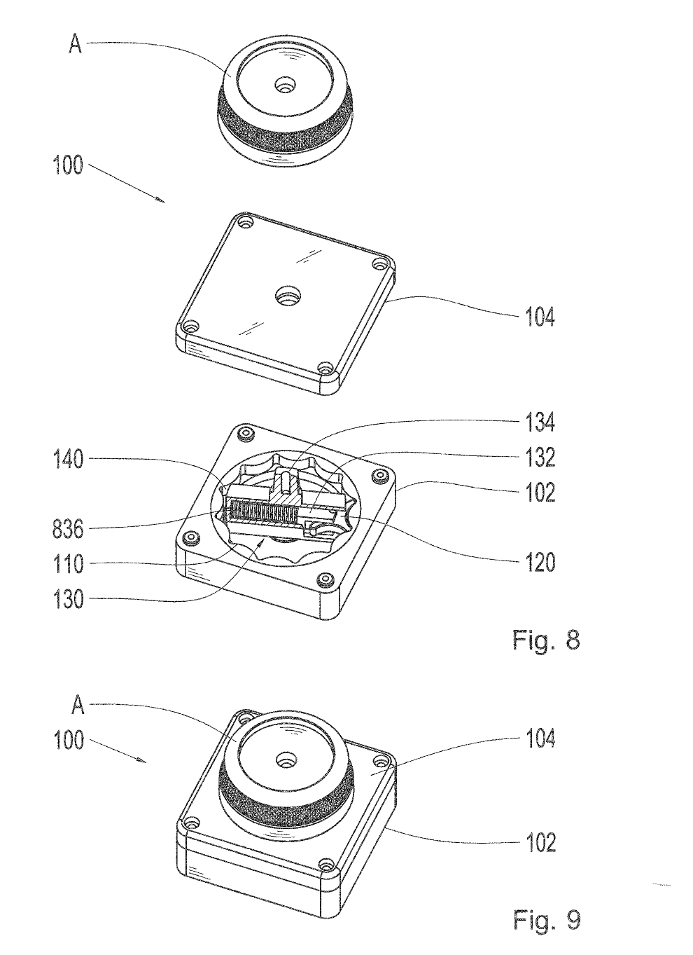

FIG. 8 is a perspective view of an adjusting device according to a further embodiment of the present disclosure in a partially mounted condition;

FIG. 9 is a perspective view of the device shown in FIG. 8 in a mounted condition;

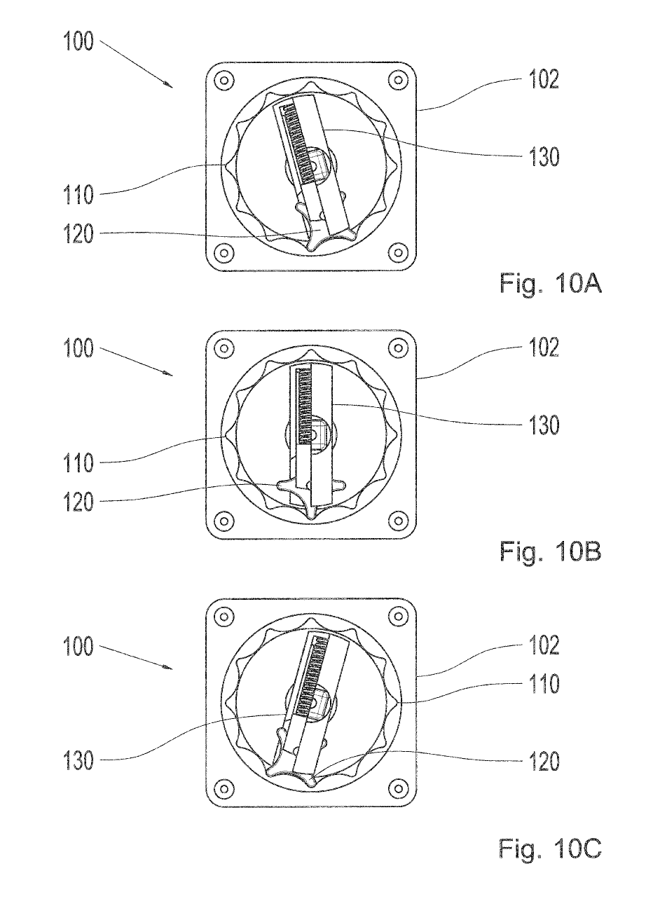

FIGS. 10A to 10C are top views of the device shown in FIG. 8 or FIG. 9 in different conditions of movement; and

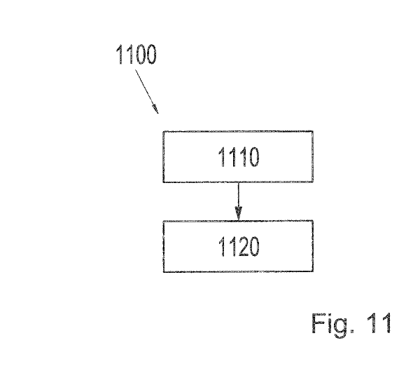

FIG. 11 is a flow diagram of an adjusting method according to an embodiment of the present disclosure.

In the subsequent description of preferred embodiments of the present disclosure, the same or similar reference numerals are used for the elements shown in the different figures and acting in a similar manner, thus avoiding to repeat the description of these elements.

FIG. 1 shows a perspective view of an adjusting device 100 or device for setting according to an embodiment of the present disclosure in a partially mounted condition. In other words, FIG. 1 shows a partially exploded view of the adjusting device 100. The adjusting device 100 is designed to adjust a rotational movement or pivoting movement of a control element A for a vehicle. The adjusting device 100 is designed in the form of a so-called latching device. To be precise, FIG. 1 shows the adjusting device 100 and the control device A in a partially exploded view.

According to the embodiment of the present disclosure shown in FIG. 1, the adjusting device 100 has a housing 102 and a cover 104. The housing 102 and the cover 104 are produced in such a way that they can be attached to each other or screwed to each other. In an exemplary manner, the housing 102 and the cover 104 have a floor space with a square profile, which has rounded edges. In particular, the housing 102 and the cover 104 are produced from a plastic material or the like. In mounted condition of the adjusting device 100, the cover 104 is arranged between the housing 102 and the control element A.

The adjusting device 100 comprises a latching contour 110, a latching element 120 and a power transmitting device 130, arranged and/or formed, for example, in the area of the housing 102. The latching contour 110, the latching element 120 and the power transmitting device 130 are formed, for example, from a plastic material or different plastic materials.

The latching contour 110 has a curved progression. The latching contour 110 is designed to define at least one shift position of the control element A along a circular or arched movement path of the control element A. According to the embodiment of the present disclosure shown in FIG. 1, the latching contour 110 is arranged in a sidewall area of a passage opening or recess portion of the housing 102. In particular, the latching contour 110 has a circular shape. At the same time, the latching contour 110 has the course of a cycloid, especially a shortened cycloid, along a circular guide curve.

The latching element 120 is shaped and designed to engage in the latching contour 110. The latching element 120 is also designed to be moved in rolling fashion along the latching contour 110. In mounted condition of the adjusting device 100, the latching element 120 is in mechanical contact with the latching contour 110. According to the embodiment of the present disclosure shown in FIG. 1, the latching element 120 is designed in the form of a latching roller with multiple legs, especially four legs. Subsequently, the latching element 120 is described in more detail, especially with reference to FIG. 3.

The power transmitting device 130 is designed to rotatably bear the latching element 120. Furthermore, the power transmitting device 130 can be mechanically connected with the control element A. To be precise, the power transmitting device 130 is designed to absorb an operating force exerted on the control element A during a rotational movement or pivoting movement of the control element A and to transfer the absorbed operating force to the latching element 120. Because of the operating force transferred by the power transmitting device 130 from the control element A to the latching element 120, the latching element 120 can be moved in rolling fashion along the latching contour.

According to the embodiment of the present disclosure shown in FIG. 1, the power transmitting device 130 also comprises a support portion 132 and a coupling section 134. The support portion 132 is designed to keep the latching element 120 pivoted at the power transmitting device 130. The coupling section 134 is designed to be or become mechanically connected with the control element A. When the adjusting device 100 is mounted, the power transmitting device 130 is rotatably connected with the control element A while the control element A is rotated in the passage opening of the housing 102. At the same time, the power transmitting device 130 has a first rotational axis. When swivel-mounted at the power transmitting device 130, the latching element 120 has a second rotational axis. According to the embodiment of the present disclosure shown in FIG. 1, the first rotational axis and the second rotational axis are arranged in parallel manner to each other. Because of the operating force, the power transmitting device 130 and the latching element 120 are designed to rotate relative to each other in opposite direction about the rotational axes. Subsequently, this process is described in more detail with reference to FIGS. 4A to 4C.

Furthermore, the latching contour 110 comprises a contact section 140. The contact section 140 of the latching contour 110, which is shaped in the form of a ring cycloid, is arranged in radially inward direction. In other words, in mounted condition of the adjusting device 100, the contact section 140 faces the latching element 120. The contact section 120 is designed to enable the latching element 120 to engage in the latching contour 110.

According to the embodiment of the present disclosure shown in FIG. 1, the latching contour 110 extends over a partial section of a depth dimension of the housing 102. In particular, the latching contour 110 extends from a main surface of the housing 102 facing the cover 104 into the passage opening. As a result, the passage opening comprises in an area of the latching contour 110 a cycloid profile. Outside of the area of the latching contour 110, the passage opening comprises a circular profile. Therefore, support surface for the latching element 120 are located adjacent to the latching contour 110, to guide the latching element 120. In mounted condition of the adjusting device 100, the latching element 120 can be moved along the latching contour 110 between the support surfaces and the cover 104.

According to the embodiment of the present disclosure shown in FIG. 1, the cover 104 comprises a through-hole for the passage of the coupling section 134 of the power transmitting device 130. Therefore, when the housing 102 is screwed to the cover 104, the control element A can be mechanically connected with the power transmitting device 130 or the coupling section 134 of the power transmitting device 130.

FIG. 2 shows a perspective view of the adjusting device 100 shown in FIG. 1 in a mounted condition. Basically, the housing 102 and the cover 104 of the adjusting device 100 are shown. The housing 102 and the cover 104 are shown in mounted position in abutment against each other. The control element A is shown to be mechanically connected with the adjusting device 100.

FIG. 3 shows a perspective view of the latching element 120 of the adjusting device shown in FIG. 1 or FIG. 2. The latching element 120 comprises a centrally arranged bearing segment 322 for rotatably supporting the latching element 120 on the power transmitting device. In addition, the latching element 120 comprises a peripherally arranged engaging portion 324 for engaging in the latching contour 110.

The bearing segment 322 of the latching element 120 is formed from a hard material or a hard component with a first elasticity. The engaging portion 324 of the latching element 120 is formed from a soft material or a soft component with a second elasticity. To this end, the second elasticity of the soft material is greater than the first elasticity of the hard material. The hard component is used for supporting the latching element 120. The soft component is used to generate force and absorb noise.

According to the embodiment of the present disclosure shown in FIG. 3, at least a pin 326 or bearing pin is formed in the bearing segment 322 of the latching element 120. To this end, the pin 326 is arranged on a rotational axis of the latching element 120 or extends along a rotational axis of the latching element 120.

Generally speaking, the latching element 120 can have at least three projections 328 for engaging in the latching contour 110. According to the embodiment of the present disclosure shown in FIG. 3 the latching element 120 has four projections 328 or legs. The projections 328 extend radially from the bearing segment 322 of the latching element 120.

FIGS. 4A to 4C show top views of the adjusting device 100 shown in FIG. 1 or FIG. 2 in different conditions of movement. Of the adjusting device 100 shown in FIGS. 4A to 4C, the housing 102, the latching contour 110, the latching element 120 and the power transmitting device 130 are depicted respectively. The control element is not shown in the representations. FIGS. 4A to 4C show sequentially from FIG. 4A via FIG. 4B to FIG. 4C the adjusting device 100 in a rotational movement of the power transmitting device 130 in clockwise direction, wherein the latching element 120 rolls in a rotational movement in counter-clockwise direction along the latching contour 110.

According to a further embodiment of the present disclosure, FIG. 5 shows a perspective view of an adjusting device 100, or a device for setting, in a partially mounted condition. The representation shown in FIG. 5 corresponds to the representation shown in FIG. 1, and the adjusting device 100 shown in FIG. 5 corresponds to the adjusting device shown in FIG. 1, with the exception that in the adjusting device 100 shown in FIG. 5 at least the contact section 140 of the latching contour 110 is formed from a soft material with an elasticity that is greater than the elasticity of material of the power transmitting device 130 and/or housing 102. In particular, the latching contour 110 shown in FIG. 5 is formed from a soft material. The soft material or the soft component used to generate force and absorb noise. In an area of the latching contour 110, the passage opening in the housing 102 has a wavelike profile, in which the soft material of the cycloid latching contour 110 is arranged in radially inward direction.

FIG. 6 shows a perspective view of the adjusting device 100 shown in FIG. 5 in a mounted condition. The figure basically shows the housing 102 and the cover 104 of the adjusting device 100. The housing 102 and the cover 104 are shown in a mounted condition in abutment with each other. The control element A is shown to be mechanically connected with the adjusting device 100.

FIGS. 7A to 7C show top views of the adjusting device 100 shown in different conditions of movement in FIG. 5 or FIG. 6. From the adjusting device 100 shown in FIGS. 7A to 7C, the housing 102, the latching contour 110, the latching element 120 and the power transmitting device 130 are shown, respectively. The control element is not shown in the representations. FIGS. 7A to 7C show sequentially from FIG. 7A via FIG. 7B to FIG. 7C the adjusting device 100 in a rotational movement of the power transmitting device 130 in clockwise direction, wherein the latching element 120 rolls in a rotational movement in counter-clockwise direction along the latching contour 110.

According to a different embodiment of the present disclosure, FIG. 8 shows a perspective view of an adjusting device 100, or device for setting, in a partially mounted condition. The representation shown in FIG. 8 corresponds to the representation shown in FIG. 5, and the adjusting device 100 shown in FIG. 8 corresponds to the adjusting device shown in FIG. 5, with the exception that in the adjusting device 100 shown in FIG. 8 the power transmitting device 130 comprises an elastic means 836, which is designed to preload the latching element 120 in abutment against the latching contour 110, and that the passage opening in the housing 102 has also in the area of the latching contour 110 a circular profile, on which the soft material of the cycloid latching contour 110 is arranged in radially inward direction. Therefore, the soft material of the latching contour 110 shown in FIG. 8 has a different form than the one shown in FIG. 5.

According to the embodiment of the present disclosure shown in FIG. 8, the elastic means 836 of the power transmitting device 130 is designed in the form of a compression spring, for example, in the form of a coil spring guided in a guidance. At the same time, the elastic means 836 is arranged between the support portion 132 and coupling section 134. To this end, the support portion 132 and the coupling section 134 can be moved in relation to each other.

FIG. 9 shows a perspective view of the adjusting device 100 shown in FIG. 8 in a mounted condition. Basically, the housing 102 and the cover 104 of the adjusting device 100 are shown. The housing 102 and the cover 104 are shown in a mounted position in abutment against each other. The control element A is shown to be mechanically connected with the adjusting device 100.

FIGS. 10A to 10C show top views of the adjusting device 100 shown in FIG. 8 or FIG. 9 in different conditions of movement. From the adjusting device 100 shown in FIGS. 10A to 10C, the housing 102, the latching contour 110, the latching element 120 and the power transmitting device 130 are shown, respectively. The control element is not shown in the representations. FIGS. 10A to 10C show sequentially from FIG. 10A via FIG. 10B to FIG. 10C the adjusting device 100 in a rotational movement of the power transmitting device 130 in clockwise direction, wherein the latching element 120 rolls in a rotational movement in counter-clockwise direction along the latching contour 110.

FIG. 11 shows a flow diagram of a method 1100 for setting according to the embodiment of the present disclosure. The method 1100 can be performed to adjust a rotational movement or pivoting movement of a control element for a vehicle. At the same time, the method 1100 can be performed in conjunction with an adjusting device or a device for setting a rotational movement or pivoting movement of a control element for a vehicle. For example, the adjusting device or device for setting involves the adjusting device shown in any one of the FIGS. 1 to 10C or a similar device.

The adjusting device, which is used to perform the method 1100 comprises a curved latching contour for defining at least one shift position of the control element. In addition, the device comprises a latching element to engage in the latching contour. Furthermore, the device comprises a power transmitting device, with which the control element can be mechanically connected to absorb an operating force exerted on the control element during the rotational movement or pivoting movement of the control element and transfer said operating force to the latching element. The latching element can be arranged to be swivel-mounted on the power transmitting device, wherein because of the operating force the latching element can be moved in rolling fashion along the latching contour.

The method 1100 comprises a step 1110 of absorbing and a step 1120 of transmitting. In step 1110 of absorbing, the operating force is absorbed by the control element by means of the power transmitting device. In step 1120 of transmitting, the absorbed operating force is transmitted to the latching element by means of the power transmitting device.

The embodiments described and shown in the figures have been selected only as examples. Different embodiments can be completely or with respect to specific characteristics combined with each other. It is also possible to supplement an embodiment with characteristics of a further embodiment. Furthermore, it is possible to repeat procedural steps or perform said steps in a sequence different from the one described.

If an embodiment comprises an “and/or” connection between a first characteristic and a second characteristic, this can be read in such a way that, according to one embodiment, the model has the first characteristic and the second characteristic and according to another embodiment, the model has only the first characteristic or only the second characteristic.

### REFERENCE SIGNS

100 Device for setting or adjusting device or latching device
102 Housing
104 Cover
110 Latching contour
120 Latching element
130 Power transmitting device
132 Support portion
134 Coupling section
140 Contact section
322 Bearing segment
324 Engaging portion
326 Pin
328 Projection
836 Elastic means
1100 Method for adjusting
1110 Step of absorbing
1120 Step of transmitting
A Control element

1. A device for setting a rotational movement or pivoting movement of a control element comprising:
a curved latching contour for defining at least a shift position of the control element,
a latching element for engaging in the latching contour, and
a power transmitting device, with which the control element can be mechanically connected in order to absorb an operating force exerted on the control element during the rotational movement or pivoting movement and transmitting said forces to the latching element,
wherein the latching element can be arranged to be swivel-mounted on the power transmitting device,
wherein due to the operating force the latching element can be moved in rolling fashion along the latching contour.

2. The device according to claim 1, wherein the latching element comprises a centrally arranged bearing segment for supporting the power transmitting device and a peripherally arranged engaging portion for engaging in the latching contour.

3. The device according to claim 2, wherein the bearing segment of the latching element is formed from a hard material with a first elasticity, and the engaging portion of the latching element is formed from a soft material with a second elasticity, wherein the second elasticity of the soft material is greater than the first elasticity of the hard material.

4. The device according to any one of the preceding claims, wherein the latching element comprises at least three projections for engaging in the latching contour.

5. The device according to claim 1, wherein the latching contour has a contact section which is designed to enable an engagement of the latching element, wherein at least the contact section of the latching contour is formed from a soft material with an elasticity that is greater than an elasticity of a material of the power transmitting device.

6. The device according to claim 1, wherein the power transmitting device comprises an elastic element, which is designed to preload the latching element in abutment against the latching contour.

7. The device according to claim 1, wherein the latching contour has a circular design, wherein a contact section of the latching contour, which is designed to enable an engagement of the latching element, is arranged in a radially inward direction.

8. The device according to claim 1, wherein the power transmitting device has a first rotational axis and the latching element has a second rotational axis, wherein the first rotational axis and the second rotational axis are arranged in parallel manner to each other,
wherein, because of the operating force, the power transmitting device and the latching element are designed to rotate relative to each other in opposite direction about the rotational axes.

9. A shifting device, in particular for shifting an automatic transmission of a vehicle, wherein the shifting device comprises a control element and a device for setting according to claim 1, wherein the control element can be connected with the power transmitting device of the device for setting.

10. A method for setting a rotational movement or pivoting movement of a control element of a shifting device, wherein the shifting device comprises a curved latching contour for defining at least a shift position of the control element, a latching element for engaging in the latching contour, and a power transmitting device, with which the control element can be mechanically connected in order to absorb an operating force exerted on the control element during the rotational movement or pivoting movement and transmitting said forces to the latching element, wherein the latching element can be arranged to be swivel-mounted on the power transmitting device, wherein due to the operating force the latching element can be moved in rolling fashion along the latching contour, wherein the method comprises the following steps: a step in which
the control element absorbing the operating force through the power transmitting device of the shifting device and
transmitting the operating force through the power transmitting device to the latching element of the shifting device.

11. The device according to claim 8, wherein the power transmitting device rotates in a first plane and the latching element rotates in a second plane, wherein the first plane and second plane are parallel, wherein the first plane is different than the second plane.

12. The device according to claim 8, wherein the power transmitting device rotates in a first plane and the latching element rotates in a second plane, wherein the first plane is the same as than the second plane.

13. The device according to claim 1, further comprising a housing and a cover, wherein the housing encloses the curved latching contour, the latching element, and at least a portion of the power transmitting device, wherein the cover can be attached to the housing.

14. The device according to claim 13, wherein the latching contour is disposed in a sidewall of the housing.

15. The device according to claim 13, wherein the latching contour extends in a perpendicular direction from a surface of the housing that faces the cover.

16. The device according to claim 13, wherein the latching contour is disposed in a passage opening in the housing, wherein an area in the passage opening outside the latching contour is circular in shape.

17. The device according to claim 1, wherein the latching contour, the latching element, and the power transmitting device are formed from a plastic material.

18. The device according to claim 6, wherein the elastic element comprises a spring.

19. The device according to claim 1, wherein the latching contour has a cycloid shape.

20. The device according to claim 1, wherein the power transmitting device comprises a support portion and a coupling section, wherein the support portion is rotatably connected to the latching element and the coupling section is non-rotatably connected to the control element.
